(19) United States
(12) Patent Application Publication
(10) Pub. No.: US 2004/0246327 A1
(43) Pub. Date: Dec. 9, 2004

(54) Manually position ink jet printing device for making tattoos

(76) Inventor: Marco Elzi, Chivasso (IT)

Correspondence Address: BANNER & WITCOFF, 1001 G STREET N W, SUITE 1100, WASHINGTON, DC, 20001, US

(21) Appl. No.: 10/491,442

(22) PCT Filed: Oct. 10, 2002
(86) PCT No.: PCT/IT02/00649

(30) Foreign Application Priority Data
Oct. 16, 2001 (IT) TO2001A000976

(51) Int. Cl. B41J 3/36

(52) U.S. Cl. 347/109

(57) ABSTRACT

An ink jet printing device (40) is adapted for being manually positioned by a user on the skin (54) of a human being or animal, for printing tattoos (55) thereon, and comprises an outer support case (41) having a front part (42) which is suitable for cooperating in contact with the skin (54), and which in turn includes an aperture (44) for defining a given portion (54a) of the skin that is to be printed.

### TECHNICAL FIELD

This invention relates to a manually positionable ink jet printing device, having a printhead with a plurality of nozzles, used for forming black or colour images on the skin of a human being or animal.

### BACKGROUND ART

More specifically, the invention concerns an ink jet printing device, suitable for being handled by an operator to be brought into contact with the skin of a human being or animal, for printing black and white or colour images, and in particular tattoos, on a given portion of skin.

In the field of tattoos, in addition the permanent ones, in which the ink is injected into the skin using needles, various types of temporary tattoos are known, the main characteristic of which is that they are easy to remove. The easiest method for obtaining removable tattoos is to use transfers or the like; in this case, the image is transferred easily to the epidermis and removed just as easily; the main disadvantage is the cost, which increases as the number of colours in the design increases. Further, the designs are not open to personalization. Special adhesive sheets are also known which can be printed on a common printer (U.S. Pat. No. 6,042,881), before being applied to the skin. In this way the designs can be personalized, but the process is fairly complicated and the special paper is expensive. To overcome this drawback, patent WO 01/49360 demonstrates equipment that allows a tattoo to be printed directly on the skin, using an ink jet head. The invention described has the disadvantage of comprising complex equipment for positioning the printhead with respect to the medium (human or animal skin) to be printed and does not permit use by the user.

The inks to be used must be non-toxic and biocompatible; if water-based inks are used, images are obtained that are easily washed off. The portion of skin that the tattoo is applied on can be treated in advance with products that clean it and reduce its roughness, to allow better quality printing.

### DISCLOSURE OF THE INVENTION

A first object of this invention is that of producing an ink jet printing device, to produce tattoos on the skin, that is less expensive and more practical to use than the solutions known at present.

A second object is that of producing a handy device that is easy to position on the area of the skin on which the tattoo is to be printed.

A third object is that of producing a device that allows printing of the desired tattoo to be obtained quickly.

A fourth object is that of producing a device that allows the printing of tattoos to be obtained at low costs.

A fifth object is that of producing a device for making tattoos that can be activated simply by a user.

These objects are achieved by the device for printing tattoos according to this invention.

These and other objects, characteristics and advantages of the invention will become apparent in the course of the following description of a preferred embodiment, provided by way of non-restrictive example, with reference to the accompanying drawings.

### BRIEF DESCRIPTION OF DRAWINGS

FIG. 1-Represents a perspective, enlarged view of a printer for tattoos according to the invention;

FIG. 2-Represents a plan view of the support base of the printer for tattoos of FIG. 1.

### BEST MODE FOR CARRYING OUT THE INVENTION

This invention is a manually positionable, ink jet device for the printing of images in black and white or colour such as, in particular, tattoos, on the skin of a human being or animal, using biocompatible inks.

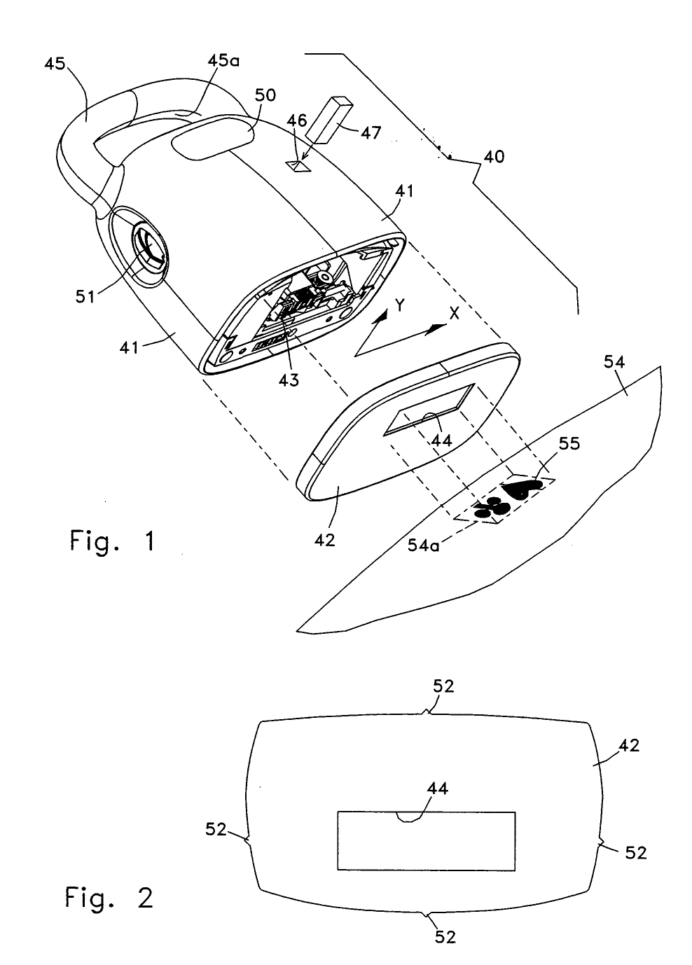

Depicted in FIG. 1 is a printer 40, comprising an outer case 41, a support base 42, a black and white or colour inkjet printhead 43, also called printing unit, and an aperture 44.

Also shown in FIG. 1 are the reference axes:

x axis: parallel to the direction of the greater side of the aperture 44; y axis: parallel to the direction of the lesser side of the aperture 44.

The printhead 43 is of known characteristics and comprises nozzles, not depicted in the drawing, generally arranged in two columns parallel to the y axis. The nozzles have a diameter D of between 10 and 60 mm, while their centres are generally apart by pitch of 1/150 or 1/300 of an inch (169 μm or 84.5 μm). Usually the resolution of the image in the direction parallel to the y axis is 1/300 or 1/600 of an inch (84.5 μm or 42.3 μm).

During printing, the head 43 is made move in two directions parallel to the x and y axes.

The construction and general mode of operation of an ink jet printer according to the thermal technology are already widely known in the art, and will not therefore be described in detail herein.

The printer 40 is powered by rechargeable batteries, and is accommodated, in the rest position, on a recharge station connected to the mains, not depicted in any of the figures.

The outer case 41 is shaped as a dome, in the top of which a handle 45 is made, by means of which the printer 40 is manually positioned by an operator on the portion of skin 54a on which a tattoo 55 is to be printed.

Between the handle 45 and the top part of the outer case 41, there is an aperture 45a for the passage of at least four of the operator's fingers, in such a way as to allow the latter to grip the printer 40 simply and to place it on the portion of skin 54a, on which a tattoo 55 is to be printed.

Also made in the outer case 41 is a slot 46, for the insertion of a ROM type memory 47, for example a memory card or a smart card or similar memories; the memory 47 contains stored within a series of images to be printed by means of the printhead 43 in such a way as to produce tattoos 55 on the portion of skin 54a. each image to be printed is identified by an alphanumeric code, which is posted on a display 50.

The image to be printed is selected by means of one or more buttons 51, which allow alphanumerical codes to be scrolled on the display 50. Printing is performed later by pressing a button, not depicted in the figures, located on the outer case 41 in the vicinity of the handle 45.

In correspondence with the part of the outer case 41 that is placed on the skin 54 during printing of the tattoo 55, is the support base 42, made in such a way as to allow, through the aperture 44, the ejection of the droplets of ink on the portion of skin 54a on which a tattoo 55 is to be printed.

FIG. 2 describes a detail of the support base 42: made in the outer surface of the support base 42 are four reference notches 52, which allow the printer 40 to be positioned correctly on the portion of skin 54a that has to be printed.

Clearly changes and improvements may be made to the printing device described up to now, without departing from the scope of this invention.

1. Ink jet printer (40) for printing symbols and images, particularly tattoos (55), on the skin (54) of a human being or animal, comprising a printing unit (43) of the ink jet type, and a support case (41) for said printing unit (43), characterized in that said printer (40) comprises gripping means (45) to allow an operator to grip and handle said printer (40), and bring it into contact with said skin (54), and supporting means (42) for setting said printer on said skin (54), wherein said supporting means (42) are suitable for defining a given portion (54a) of said skin (54) intended to be printed on with said printing unit (43) and for maintaining, during the printing step, said skin (54) at a given distance from said printing unit (43).

2. Printer according to claim 1, characterized in that said supporting means (42) include an aperture (44), in which the printing of said given portion (54a) of skin is performed by ejecting, through said printing unit (43), droplets of ink through said aperture (44).

3. Printer according to claim 1, characterized in that said gripping means comprise a curved shape handle (45) defining an aperture (45a) for allowing the passage of at least four fingers of the hand of the operator, in such a way that said handle (45) may be gripped between these four fingers and the thumb of the operator's hand.

4. Printer according to claim 1, characterized in that said case (41) comprises a handle-shaped end portion (45), defining said gripping means, wherein said end portion (45) is rigidly connected at the two opposite ends to the outer surface of said case to form an aperture (45a) suitable for permitting the passage of at least four fingers of the operator's hand.

5. Printer according to claim 1, characterized in that said printing unit (43) is suitable for moving in two directions (X, Y) perpendicular to one another, for printing said symbols and images on the skin of said human being or animal.

6. Printer according to claim 1, characterized in that it comprises a slot (46) for inserting a memory (47) containing, in stored form, one or more images to be printed on said skin.

7. Printer according to claim 1, characterized in that it comprises, on the outer surface of said support case, a display (50) for displaying the operating status of said printer (40).

8. Printer for the printing of symbols and images, particularly tattoos, on the skin of a human being or animal substantially as described with reference to the accompanying drawings.
